(19) United States
(12) Patent Application Publication
(10) Pub. No.: US 2016/0140353 A1
(43) Pub. Date: May 19, 2016

(54) METHOD AND APPARATUS FOR PROTECTING LOCATION DATA EXTRACTED FROM BRAIN ACTIVITY INFORMATION

(71) Applicant: Nokia Corporation, Espoo (FI)

(72) Inventors: Debmalya BISWAS, Lausanne (CH); Julian NOLAN, Pully (CH); Matthew John LAWRENSON, Bussigny-pres-de-lausanne (CH)

(21) Appl. No.: 14/547,848

(22) Filed: Nov. 19, 2014

(51) Int. Cl. G06F 21/62

(52) U.S. Cl. CPC G06F 21/62

(57) ABSTRACT

An approach is provided for protecting location data extracted from brain activity information. A privacy platform causes, at least in part, a mapping of brain activity information associated with at least one user to one or more locations visited by the at least one user. The privacy platform further determines one or more privacy policies associated with the one or more locations. The privacy platform then causes, at least in part, a transmission of at least the brain activity information, the one or more locations, or a combination thereof based, at least in part, on the one or more privacy policies.

### BACKGROUND

Service providers and device manufacturers are continually challenged to deliver value and convenience to consumers by, for example, providing compelling applications and services. One area of interest has been development of new sensor technologies and modes of interaction. For example, recent advances have focused on monitoring brain activity information to provide contextual information as well as for interaction with applications and services. However, current research has shown that memories stored in brains are “geo-tagged” based on location—e.g., using a GPS-like brain system. This finding, for instance, implies brain activity (e.g., the firing of neurons) during the retrieval of each memory is coupled with a location (i.e., location data) in the environment where the memory was initially encoded. Consequently, as the use of brain activity information (e.g., information that may be based on the retrieval of geo-tagged memories) becomes more prevalent for applications and services, service providers face significant technical challenges to ensuring that such brain activity information and the location data contained therein or associated with are maintained according to the privacy preferences of end users.

### SOME EXAMPLE EMBODIMENTS

Therefore, there is a need for protecting the privacy of location data extracted from brain activity information.

According to one embodiment, a method comprises causing, at least in part, a mapping of brain activity information associated with at least one user to one or more locations visited by the at least one user. The method also comprises determining one or more privacy policies associated with the one or more locations. The method further comprises causing, at least in part, a transmission of at least the brain activity, the one or more locations, or a combination thereof information based, at least in part, on the one or more privacy policies.

According to another embodiment, an apparatus comprises at least one processor, and at least one memory including computer program code for one or more computer programs, the at least one memory and the computer program code configured to, with the at least one processor, cause, at least in part, the apparatus to initiate a mapping of brain activity information associated with at least one user to one or more locations visited by the at least one user. The apparatus also is caused to determine one or more privacy policies associated with the one or more locations. The apparatus further causes, at least in part, a transmission of at least the brain activity, the one or more locations, or a combination thereof information based, at least in part, on the one or more privacy policies.

According to another embodiment, a computer-readable storage medium carries one or more sequences of one or more instructions which, when executed by one or more processors, cause, at least in part, an apparatus to initiate a mapping of brain activity information associated with at least one user to one or more locations visited by the at least one user. The apparatus also is caused to determine one or more privacy policies associated with the one or more locations. The apparatus further causes, at least in part, a transmission of at least the brain activity information, the one or more locations, or a combination thereof based, at least in part, on the one or more privacy policies.

According to another embodiment, an apparatus comprises means for determining in-game behavior data associated with at least one user while the at least one user is playing at least one location-based game. The apparatus also comprises means for causing, at least in part, a mapping of brain activity information associated with at least one user to one or more locations visited by the at least one user. The apparatus further comprises means for determining one or more privacy policies associated with the one or more locations. The apparatus further comprises means for causing, at least in part, a transmission of at least the brain activity information, the one or more locations, or a combination thereof based, at least in part, on the one or more privacy policies.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the filed claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of protecting location data extracted from brain activity information, according to one embodiment;

FIG. 2 is a diagram of the components of a privacy preserving module/privacy preserving platform, according to one embodiment;

FIGS. 3A-3D is a flowchart that summarizes an overall process for protecting location data extracted from brain activity information, according to various embodiments;

FIG. 4 is a flowchart of a process for protecting location data extracted from brain activity information, according to one embodiment;

FIG. 5 is a flowchart of a process for transmitting protected brain activity information and/or locations to applications and/or services, according to one embodiment;

FIG. 6 is a flowchart of a process for using privacy sensitivity information and/or anonymization to protect location data extracted from brain activity information, according to one embodiment;

FIGS. 7A-7C are user interface diagrams depicting a process for protecting location data extracted from brain activity information, according to various example embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for protecting location data extracted from brain activity information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the various embodiments discussed herein refer to protecting location data extracted from brain activity information based on privacy policies, it is contemplated that the approaches presented in the embodiments are also applicable to any type of policy (e.g., security policy, access policies, etc.) that can be applied to a user device. Moreover, although the policies described herein are discussed as location-based policies (e.g., polices associated with specific locations such as virtual and/or real-world locations), it is contemplated that the approaches presented in the embodiments are also applicable to policies based on other contextual parameters (e.g., by contact, by activity, by time, etc.).

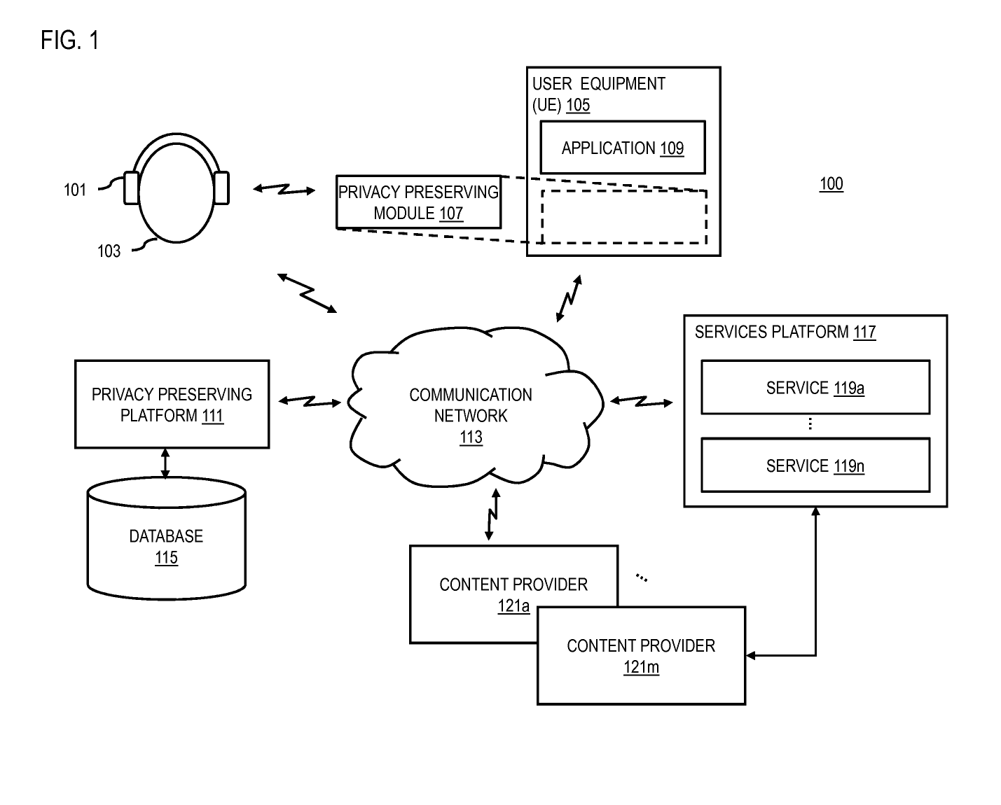

FIG. 1 is a diagram of a system capable of protecting location data extracted from brain activity information, according to one embodiment. Advances in sensor technology are leading to increased use of, for instance, brain-computer interfaces as means for providing information to and/or interacting with devices, applications, and/or services. In one embodiment, such brain-computer interfaces measure user brain activity information (e.g., brain cell activity such as the firing of neurons) that is then translated into information or interaction commands for use the applications and/or services. However, because of the personal nature of brain activity information and the information that can be intentionally or unintentionally mined from it, the use of such information can raise potential privacy concerns.

For example, as discussed above, current research indicates that during memory formation, the human brain may use a brain-based location sensing system to tag memories. In other words, as a memory is encoded in the brain, location data is also encoded into the firing of neurons or other brain activity. This implies that the firing of neurons during the retrieval of each memory is coupled with the location in the environment where the memory was initially encoded. This finding implies that the user's location can be potentially determined by monitoring brain activity data (e.g., brain cell activity arising from the firing of neurons when a memory is retrieved) alone. In other words, the user's current location can be inferred based on only the user's brain activity information—at least for previously visited locations—(e.g., by monitoring the firing of neurons when the user's brain accesses memories associated with the current location) even if other positioning techniques (e.g., GPS or other location sensors on the user's device) are turned off.

This raises potential privacy risks associated with sharing brain activity data and/or locations extracted from the brain activity data (e.g., with applications and/or services that request or use the brain activity data). For example, if an attacker knows a mapping of the user's brain activity with respect to the location(s) that triggers the brain activity, and if the attacker can monitor the user's brain activity such that the attacker knows what brain activity occurred (e.g. which neuron fired), the attacker can infer that the user is at a particular location.

To address this problem, a system 100 of FIG. 1 introduces a capability to protect location data extracted from brain activity information by, firstly, mapping brain activity information (e.g., specific brain cells or neurons that have fired) to locations previously visited by a user. In one embodiment, the system 100 then determines whether to transmit or share the brain activity information and/or locations of interest based on policies specified by the user for the location that can be inferred from the brain activity information (e.g., based on the mapping). In other words, the sharing of the brain activity information is controlled in dependence on the privacy policy corresponding to the location information or data that can be extracted from the brain activity information.

In one embodiment, the locations associated with the brain activity information can be either physical locations or virtual locations. For example, physical locations represent real-world or real-life locations at which a user forms a memory or causes other brain stimuli to associate a particular brain activity (e.g., a firing of a neuron). Virtual locations can represent locations encountered by the user in a virtual environment such as a game, a virtual reality world, a fictional immersive experience, and the like. Just as with the physical locations, the user can form a memory or have other brain stimuli associated with virtual locations that can be geo-tagged by the brain. For example, the human brain can treat virtual locations (e.g., those encountered in a three-dimensional game) and physical locations in a similar fashion with respect to geo-tagging memories. In other words, like memories associated with physical locations, the same brain activity occurs (e.g., the same neurons are activated or fired) when a user visits a virtual location for a subsequent time after the memory is formed.

In yet another embodiment, the system 100 can evaluate additional factors to determine whether to share or transmit the brain activity information and/or mapped locations. For example, the system 100 can consider: (1) the sensitivity of the location to the user; (2) the trustworthiness of an entity (e.g., an application, service, device, etc.) that is to receive or share the brain activity information; (3) historical information with respect to user interaction with the entity (e.g., information that is personal to the user or crowd-sourced from other users); and the like.

As shown in FIG. 1, in one embodiment, the system 100 includes a monitoring device 101 capable of monitoring brain activity information form a user 103. In one embodiment, the monitoring device 101 is a peripheral device to a user equipment 105 (e.g., a mobile device) that includes a privacy preserving module 107 and executes an application 109 for accessing the brain activity information. In one embodiment, the application 109 provides contextual service, location-based services, and/or other services or functions based on the brain activity information of the user 103. To support these functions, the monitoring device 101 monitors the user 103's brain activity (e.g., neuron activity) and provides the brain activity information as a feed to the application 109 and/or the UE 105. In one embodiment, the privacy preserving module 107 performs the functions associated with protecting location data extracted from the brain activity information collected by the monitoring device 101. Accordingly, the privacy preserving module 107 processes the feed from the monitoring device 101 before transmitting or sharing the feed with the application 109 and/or the UE 105 to enforce applicable privacy policies.

Although the privacy preserving module 107 is depicted as a component of the UE 105, it is contemplated that the privacy preserving module 107 may be implemented in the monitoring device 101 itself, or as a separate component of either the UE 105 or the monitoring device 101. In addition or alternatively, all or a portion of the functions of the privacy preserving module 107 can be performed by the privacy preserving platform 111 as a network component (e.g., as a cloud service) with connectivity to the monitoring device 101, the UE 105, the privacy preserving module 107, and/or the application 109 over a communication network 113. In embodiments in which the privacy preserving module 107 is implemented in the UE 105 or as the privacy preserving platform 111, the data flow from the monitoring device 101 is directed through either the privacy preserving module 107 and/or the privacy preserving platform 111 after collection and before transmission to other components of the system 100 (e.g., the application 109, the UE 105, etc.).

In one embodiment, the privacy preserving module 107 and/or the privacy preserving platform 111 maintains a mapping of the brain activity information collected by the monitoring device 101. The mapping, for instance, relates observed brain activity (e.g., a firing of a neuron) with a location (e.g., a physical or virtual location) associated with the brain activity. In one embodiment, the mapping and/or brain activity information is stored in the database 115. The privacy preserving module 107, for instance, uses the mapping to intercept and/or to respond to requests for access to the brain activity information. For example, the privacy preserving module 107 controls the sharing and/or transmission of the brain activity information (e.g., activated neuron data) with requesting entities from a location privacy perspective as discussed with the respect to the various embodiments described herein.

As previously discussed, in one embodiment, the privacy preserving module 107 can consider factors (e.g., location sensitivity, trustworthiness, need for anonymization, etc.) in combination with privacy policies to protect location data extracted from brain activity information. In one embodiment, the requests for brain activity information can originate from the application 109. In addition or alternatively, the requests may originate from the services platform 117, the services 119a-119n (collectively referred to as services 119) of the services platform 117, the content providers 121a-121m (collectively referred to as content providers 121) for providing contextual, location-based, and other services based on brain activity information.

By way of example, the monitoring device 101 is any type of device with one or more sensors for measuring the brain activity. For example, the sensors may measure the electrical and/or magnetic activity of brain cells to generate the monitoring feeds processed by the privacy preserving module 107. It is contemplated that any type or combination of brain activity sensors may be used the monitoring device 101, and that the electrically or magnetically based sensors mentioned above are provide for illustration and are not intended as limitations.

In one embodiment, the UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 105 can support any type of interface to the user (such as “wearable” circuitry, etc.).

In one embodiment, the user (and/or other parties such as a service provider) may configure the system 100 to use either the network component (e.g., the privacy preserving platform 111), the local component (e.g., the privacy preserving module 107), or the network and local components in combination to generate privacy policies. In one embodiment, the configuration of which component or components to use can be based on a user's overarching privacy settings. For example, if a user's overarching privacy setting specifies that personal data should not be transmitted outside of the user's device (e.g., the monitoring device 101 and/or the UE 105), the system 100 can configure the privacy preserving module 107 to protect location data extracted from brain activity information without exposing the information beyond the user's personal devices (e.g., the monitoring device 101 and/or the UE 105).

In one embodiment, the services platform 117 may include any type of service 119 that provides functions based on brain activity information and/or the location data contained therein. By way of example, the services platform 117 may include contextual information services, location-based services, social networking services, content (e.g., audio, video, images, etc.) provisioning services, application services, storage services, information (e.g., weather, news, etc.) based services, etc.

In one embodiment, the content providers 121 may provide content to the UE 105, the application 109, the privacy preserving module 107, the privacy preserving platform 111, the services platform 117, and/or the services 119. The content provided may be any type of content, such as textual content, audio content, video content, image content, etc. In one embodiment, the content providers 121 may provide content that may aid the privacy preserving module 107 in protecting location data extracted from brain activity information such as by providing historical application use data, privacy policy templates, recommended privacy settings, crowd-sourced privacy policies, etc. In one embodiment, the content providers 121 may also store content associated with the monitoring device 101, UE 105, the application 109, the privacy preserving module 107, the privacy preserving platform 111, and other components of the system 100. In another embodiment, the content providers 121 may manage access to a central repository of data, and offer a consistent, standard interface to user's data.

In one embodiment, the communication network 113 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the privacy preserving platform 111 may be a platform with multiple interconnected components. The privacy preserving platform 111 may include multiple servers, intelligent networking devices, computing devices, components and corresponding software for generating privacy policies based on in-game behavior data.

By way of example, the monitoring device 101, the UE 105, the privacy preserving module 107, the application 109, the privacy preserving platform 111, the services platform 117, the services 119, and the content providers 121 communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

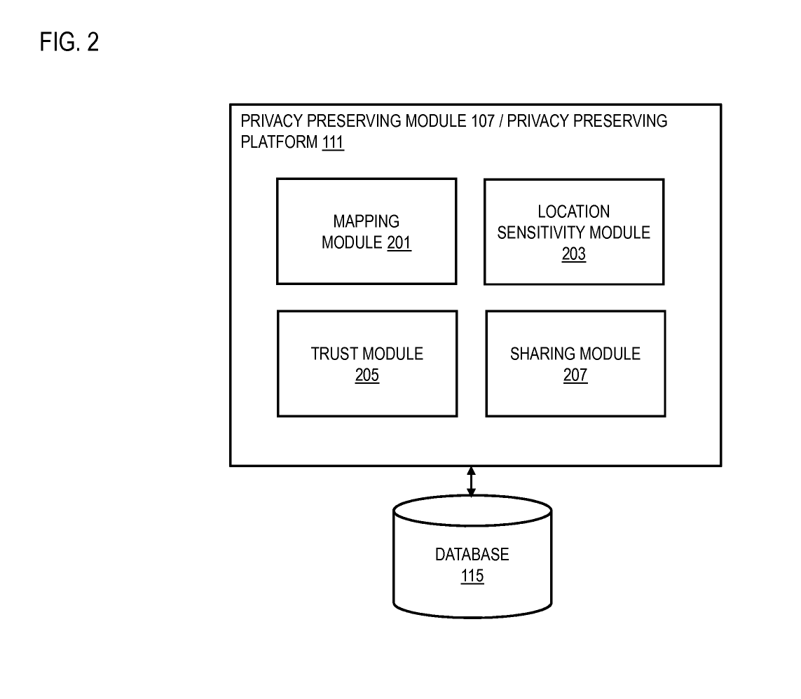

FIG. 2 is a diagram of the components of privacy preserving module/privacy preserving platform, according to one embodiment. By way of example, the privacy preserving module 107 and/or the privacy preserving platform 111 include one or more components for protecting location data extracted from brain activity information. It is contemplated that the functions of these components may be combined in one or more components or performed by other components of equivalent functionality. In this embodiment, the privacy preserving module 107 and/or the privacy preserving platform 111 include a mapping module 201, a location sensitivity module 203, a trust module 205, and a sharing module 207. The modules 201-207 also have connectivity to the database 115 for storing data associated with protecting location data extracted from brain activity information.

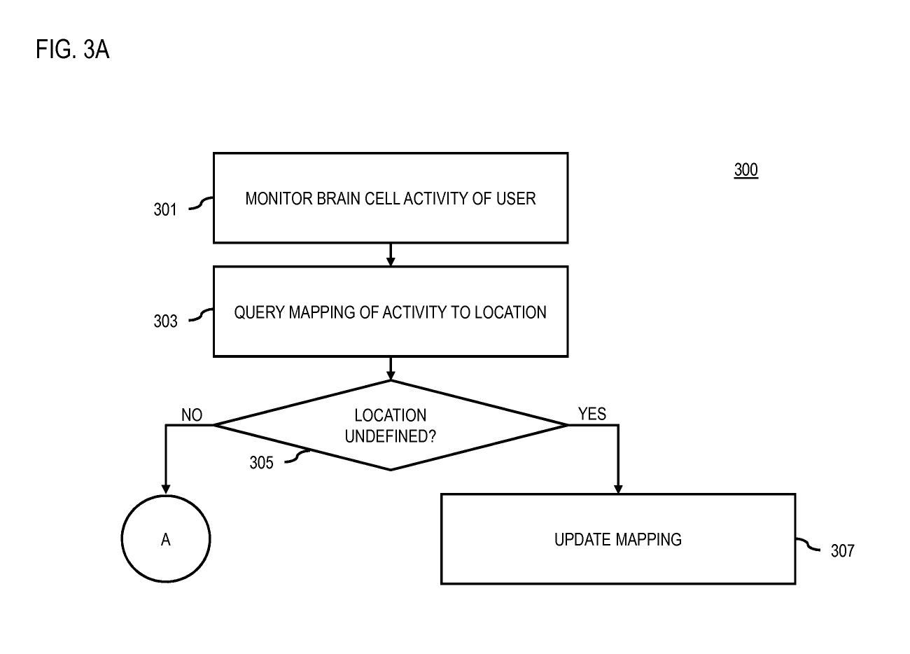

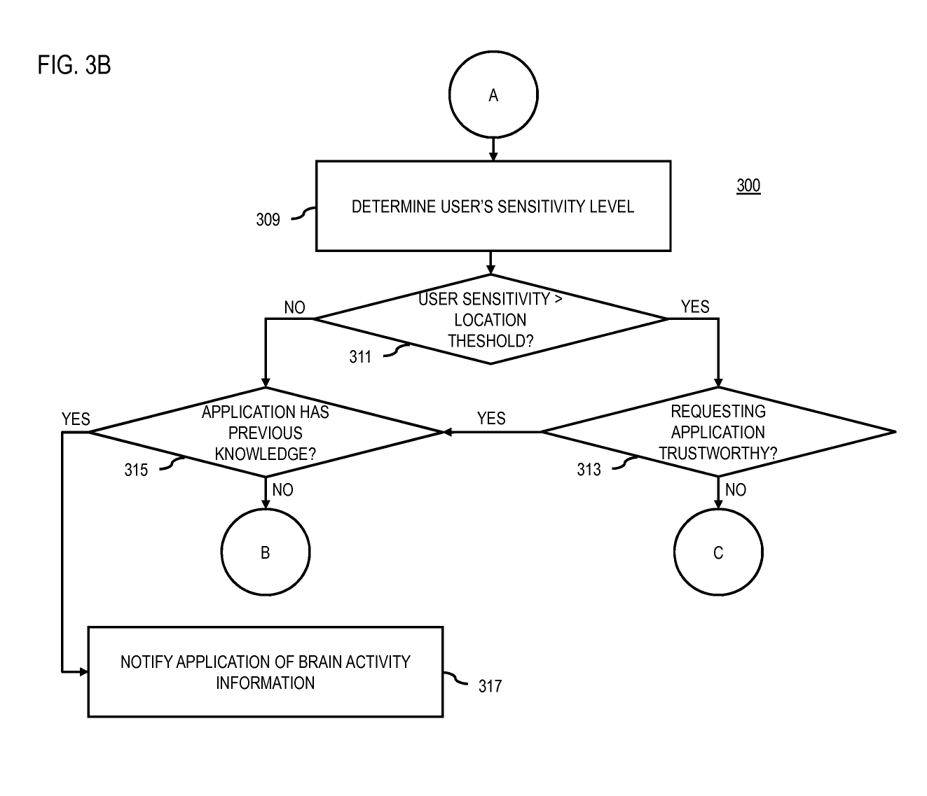

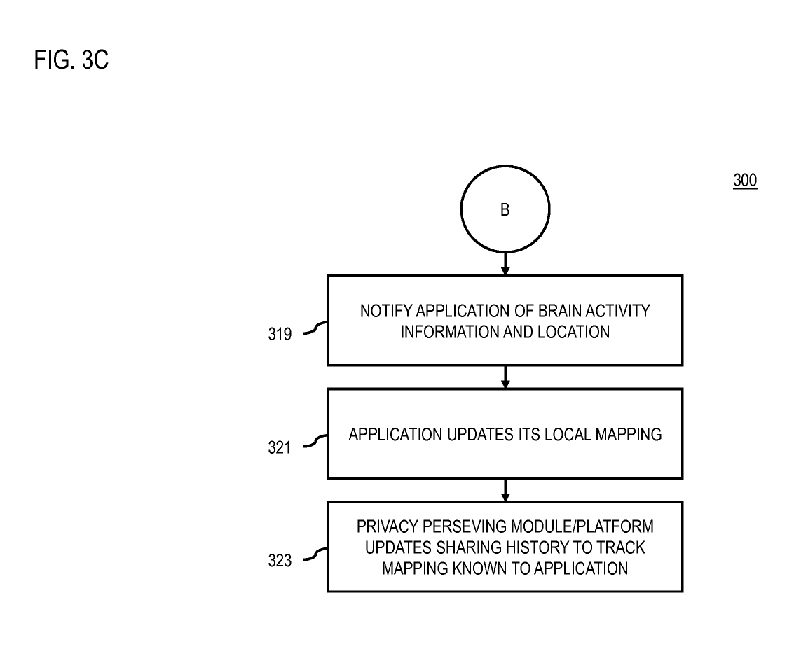

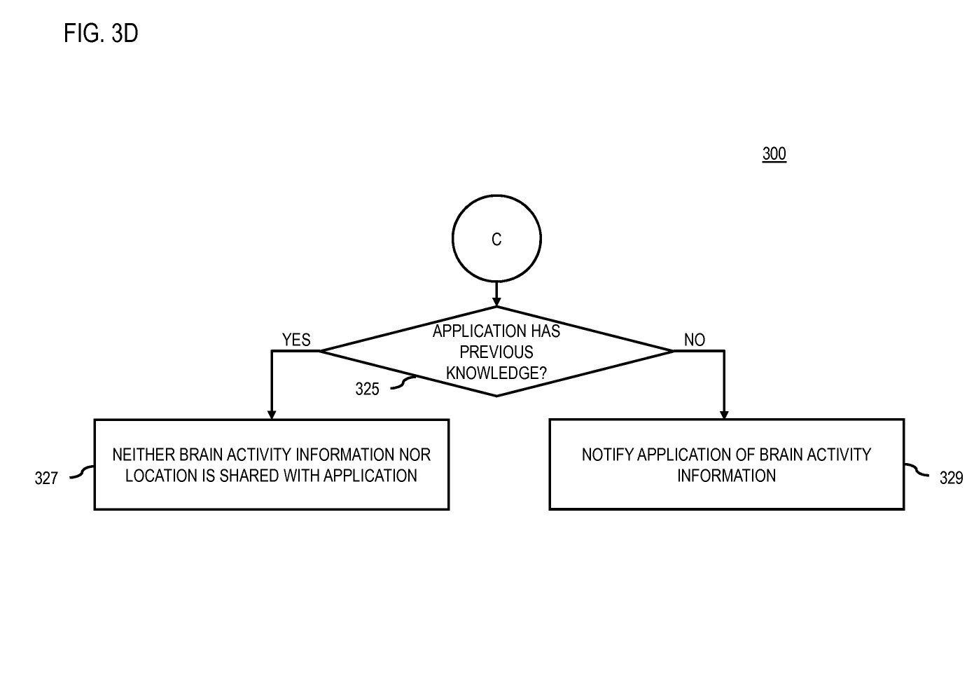

The functions of various embodiments of the modules 201-207 are described below with respect to FIGS. 3A-3D which depict a flowchart that summarizes an overall process 300 for protecting location data extracted from brain activity information. In the example of FIG. 2 and FIGS. 3A-3D, the firing of neurons is used as an example of the brain activity information that is being monitored by the privacy preserving module 107 and/or privacy preserving platform 111. For illustration, in one embodiment, the mapping module 201 creates a mapping or index that arranges the neurons in the form of a list l representing the neurons in the brain of a particular user. For example, this list is denoted as N, with a specific neuron r identified by its index in the list N, e.g., as N[i]:=rᵢ.

In one embodiment, as shown in step 301 of the process 300 FIG. 3A, the mapping module 201 monitors the brain cell activity of a user to create the mapping and populate the list N. For example, when a user visits a new place or location (e.g., physical or virtual location), memories of that place are associated with a new neuron. Accordingly, the location lᵢ (e.g., the physical location where the memory was formed) is mapped to neuron rᵢ. This implies that at any point in time, while some neurons will have an associated location, others will be “undefined”. This mapping M is denoted as follows:
M:={(N, L)}:={(r₁, l₁), (r₂, l₂), . . . , (rᵢ, lᵢ), (rᵢ₊₁, ‘undefined’), . . . , (rₙ, ‘undefined’)}

Accordingly, with respect to the terminology used above and from a location privacy perspective, the privacy issue can be formulated as follows: “If an attacker A knows the mapping M, and if the attacker A can monitor brain cell activity such that he knows which neuron fired (e.g., its index i); the attacker A can infer that the user is currently at location lᵢ—provided the user has previously been at lᵢ, and it is not ‘undefined’.” With this problem formulation, FIGS. 3A-3D provide example embodiments of the privacy preserving functions that can be taken by the privacy preserving module 107, the privacy preserving platform 111, and/or their modules 201-207.

More specifically, the process 300 of FIGS. 3A-3D illustrate the steps with respect to sharing a user U's brain activity information with an application 109. In one embodiment, the process 300 assumes that the application 109 does not have access to other positioning technologies (e.g., GPS, Wi-Fi triangulation), such that the application 109 cannot infer the user's current location by other means. In one embodiment, if the application 109 does have access to other location technologies, the privacy preserving module 107 may further restrict the sharing of brain activity information so that the application 109 cannot reconstruct the mapping of a user's brain activity information to specific locations.

By way of example, the process 300 is described with respect to following three data structures:
M_{U}: refers to the user U's neuron index—location mapping. M_{U} can be stored on the monitoring device 101, or on the UE 105 to which the monitoring device 101 is connected. In one embodiment, M_{U} is maintained (updated) by the mapping module 201 of the privacy preserving module 107, running on either the monitoring device 101 or the UE 105.
M′_{U}: refers to the (local) copy of the mapping M_{U}—corresponding to user U—maintained by the application 109. M′_{U} thus refers to the subset of M_{U}, known to the application 109.
M_{A}: is maintained by the mapping module 201, as a record (log) of the sharing history with respect to the pairings (r₁, l₁), previously shared with the application 109—e.g., the subset of M_{U}, known to the application 109. It is noted that with perfect synchronization, M′_{U}=M_{A} at any given time. The only difference is in the fact that while M′_{U} is stored and/or maintained by the application 109, while M_{A} is maintained by the mapping module 201.

As part of the mapping process, in step 303, for each brain activity or neuron fired that is determined from monitoring of the brain activity information (e.g., as in step 301), the mapping module 201 queries the neuron index—location mapping M_{U} (e.g., of a user 103) to retrieve a location lᵢ corresponding to rᵢ·M_{U}:={(rₗ, l₁), . . . , (rᵢ, ‘undefined’), . . . }. In step 305, the mapping module 201 determines whether the location lᵢ is undefined for rᵢ. If the location lᵢ is undefined, then the mapping module 201 updates the mapping M_{U} by setting location lᵢ to the user 103's current location (e.g., M_{U}:={(r₁, l₁), . . . , (rᵢ, lᵢ), . . . } (step 307).

If the location lᵢ is defined, the mapping module 201 interacts with the location sensitivity module 203 to initiate the privacy preserving steps of the process 300. For example, in step 309 of FIG. 3B, the location sensitivity module 203 determines the user 103's sensitivity level sᵢ corresponding to the location lᵢ. More specifically, the sensitivity level sᵢ quantifies and represents the privacy sensitivity of the location lᵢ based on, for instance, the user 103's current context, emotional state, accompanying people, activity, etc. In one embodiment, the location sensitivity can be determined to reflect real-time sensitivity or historical sensitivity to the location lᵢ. In other words, the “real-time” sensitivity can be determined based on a current context, emotional state, etc. of the user while “historical” sensitivity can be based on an aggregate set of the user's context, emotional state, etc. This implies, for instance, that the user 103's sensitivity sᵢ to the same location lᵢ can evolve over time so that there might be a need to restrict sharing lᵢ and/or the brain activity information with the application 109 even though the pairing (rᵢ, lᵢ) might previously have been shared with the application 109.

In step 311, the location sensitivity module 203 determines whether the sensitivity level sᵢ is greater than a privacy threshold t. In one embodiment, the privacy threshold t is defined by the user 103. Moreover, the threshold t can be specific to the given location lᵢ or more generally specified for a particular area or all areas. In one embodiment, the threshold t can be specified in one or more privacy policies created by or otherwise associated with the user 103. It is contemplated that the privacy policies may specify different thresholds for different, locations, contexts, activities, etc. If the sensitivity level sᵢ is greater than the privacy threshold t, the location sensitivity module 203 interacts with the trust module 205 to evaluate the trustworthiness of the application 109 that is requesting the brain activity information and/or the location lᵢ at step 313. If the sensitivity level sᵢ is not greater than the privacy threshold t, the trust evaluation step 313 is skipped and the process continues to step 315 to determine sharing options.

In step 313, the trust module 205 determines a trustworthiness level for the application 109. In one embodiment, the trustworthiness level is calculated based on the user's 103 personal interaction history with application 109, on crowd-sourced feedback from other user's interactions with the application 109, or a combination thereof. For example, the personal history or crowd-sourced feedback can include factors such as length of time the application is used, functions of the application 109 that are used, etc. In addition or alternatively, the trust module 205 can directly query the user 103 or other users to specify a trustworthiness level for the application 109. In another embodiment, the trust module 205 can apply machine learning techniques to process analytical data about use of the application 109 (e.g., use by the user 103 and/or other users) to calculate a trustworthiness level for the application 109.

The trust module 205 can then compare the trustworthiness level to a trust level threshold to determine how to share the brain activity information and/or location data with the application 109. For example, if the trust module 205 determines that the application 109 has a trustworthiness level above the threshold value, the trust module 205 interacts with the sharing module 207 to initiate a privacy preserving sharing process beginning at step 315. If the application 109 is not trustworthy, then the trust sharing module 207 initiates the privacy preserving process beginning at step 325 of FIG. 3D to determine whether at least some information can still be shared with the application 109.

In step 315 (e.g., the application 109 is trustworthy), the sharing module 207 determines whether to restrict or anonymize the brain activity information and/or extracted location data (e.g., location lᵢ) based on, for instance, whether the application 109 has previous knowledge of the pairing of the brain activity and location (rᵢ, lᵢ). In one embodiment, from a location privacy perspective, sharing (e.g., with the application 109) the user 103's brain activity information (e.g., data indicating that neuron rᵢ was activated can be “privacy safe”—even if the corresponding location lᵢ is “highly sensitive”—as long as the application 109 is not aware of the pairing (rᵢ, lᵢ). Accordingly, the sharing module 207 determines if the pairing is known to the application 109 by checking if (rᵢ, lᵢ) is contained within M_{A} (e.g., the log of what pairings have previously been shared with the application as maintained by the privacy preserving module 107).

In step 317, if the application 109 does have previous knowledge of the pairing, the sharing module 207 shares or transmits the brain activity information by, for instance, notifying the application 109 that neuron rᵢ was activated or fired. In this case, only the neuron information (rᵢ) is shared because the application 109 can retrieve the corresponding location li based on its local copy of the mapping for U: M′_{U}.

If the application 109 does not have previous knowledge of the pairing, the process 300 proceeds to step 319 of FIG. 3C. In this step, the sharing module 207 shares or transmits the brain activity information by notifying the application 109 that neuron rᵢ was activated or fired, and that its corresponding location is lᵢ. The application 109 then updates its local mapping M′_{U}, corresponding to the user 103's data such that M′_{U}:=M′_{U} union {(rᵢ, lᵢ)} (step 321). In step 323, the sharing module 207 also updates its sharing history with respect to the application 109 to keep track (e.g., internally within the privacy preserving module 107) that the pairing (rᵢ, lᵢ) is now known to the application such that M_{A}: =M_{A} union {(rᵢ, lᵢ)}.

Returning to step 325 of FIG. 3D, this step process the sharing process in the event that the application 109 is determined to be not trustworthy. In this case, depending on the previous knowledge of the application 109, sharing the data by restricting or anonymizing the content can still protect location privacy. Accordingly, as in step 315, the sharing module 207 determines whether the untrustworthy application 109 has previous knowledge of the pairing (rᵢ, lᵢ) by, for instance, checking if (rᵢ, lᵢ) is contained within M_{A}.

If the application 109 has previous knowledge of the pairing (rᵢ, lᵢ), the sharing module 207 restricts sharing or transmitting of the brain activity information and location data by sharing neither the neuron rᵢ nor its corresponding location lᵢ with the application 109 (step 327). In this way, the application 109 is provided with no potential new information that can be used to potentially update the pairing information that the application 109 already has.

If the application 109 has no previous knowledge of the (rᵢ, lᵢ), the sharing module 207 can still share an anonymized form of the pairing by notifying the application 109 that neuron ri was activated or fired, but not providing the corresponding location lᵢ (step 329). In this way, location privacy is protected in accordance with user privacy policies because the user 103's current location would not be known to the application 109. Therefore, the application 109 would remain unaware of the pairing (rᵢ, lᵢ) even though neuron rᵢ was shared.

As previously discussed, the location lᵢ can be either a physical or a virtual location because memory formation and geo-tagging of those memories occur similarly. Accordingly, the distinction between virtual and physical locations has (location) privacy implications particularly with the advent of multi-player location-based games that model real-life environments. For example, theses implications may arise when a user visits a physical location lₚ, whose virtual replica/model lₚᵥ he has previously “visited” in a location-based game. In this scenario, the associated memories (e.g., of the first visit) will correspond to the game environment, and the mapped location (in M) will correspond to the physical location (e.g., home) where the user was playing the game.

For instance, let rₚ be the activated neuron when user 103 visited the virtual location lₚᵥ in the game. The corresponding entry in M_{U} will however be (rₚ, lₓ), where lₓ is the physical location where the user 103 was playing the game. In the future, when the user 103 visits the corresponding physical location lₚ (in reality)—and the same neuron rₚ is activated—revealing rₚ to an untrustworthy application 109, even if lₚ is a sensitive location—might be ‘privacy safe’ as revealing rₚ to the application 109, will reveal the mapped location lₓ to the application 109, and not the actual location lₚ. Of course, it might be the case that location lₓ was actually more sensitive than lₚ—in which case the sharing decision will need to be taken considering other privacy decision factors outlined in the process 300. In one embodiment, the “virtual” location privacy aspect can be accommodated in the approaches of the various embodiments described herein by considering the sensitivity of the mapped location, and not the actual physical location.

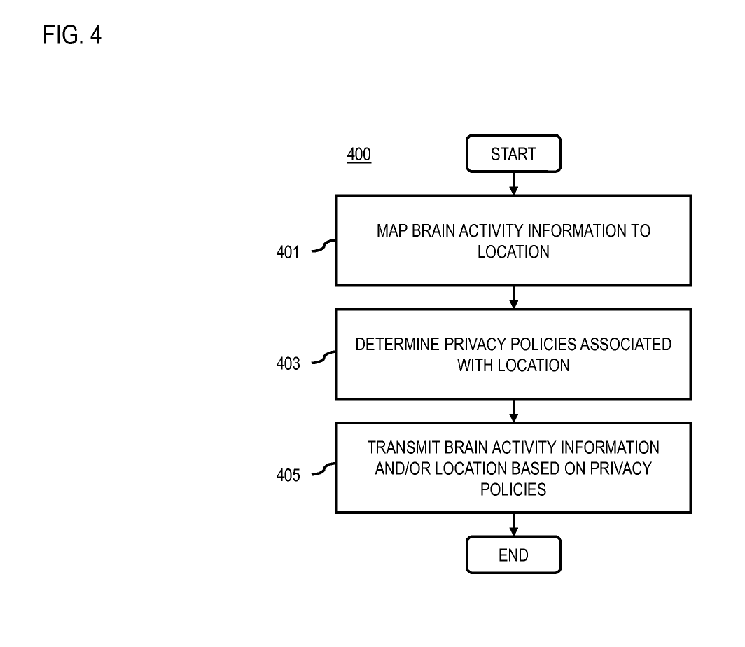

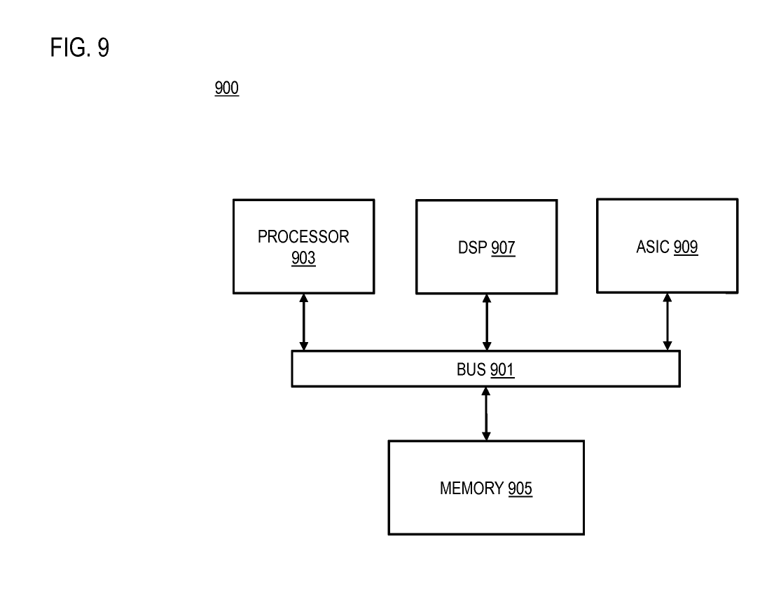

FIG. 4 is a flowchart of a process for protecting location data extracted from brain activity information, according to one embodiment. In one embodiment, the privacy preserving module 107 performs the process 400 and is implemented in, for instance, a chip set including a processor and a memory as shown in FIG. 9. In addition or alternatively, the privacy preserving platform 111 may perform all or a portion of the process 400, and may also be implemented in the chip set including the processor and the memory as shown in FIG. 9.

In one embodiment, the processes of FIGS. 4-6 are individual components of the example overall process 300 of FIGS. 3A-3D. Accordingly, the processes of FIGS. 4-6 may be performed individually or in any combination by the privacy preserving module 107 to protect location data extracted from brain activity information.

In step 401, the privacy preserving module 107 causes, at least in part, a mapping of brain activity information associated with at least one user to one or more locations previously visited by the at least one user. In one embodiment, the locations are those visited (e.g., previously or currently visited) because an initial or first visit to a location is used to trigger memory formation and location encoding into the brain. A subsequent visit to the location can then result in brain activity (e.g., neuron activation) that is linked with the memory and/or the location associated with the memory. In one embodiment, the one or more locations include, at least in part, one or more physical locations, one or more virtual locations, or a combination thereof. In other words, the privacy preserving module 107 monitors brain activity information collected by a monitoring device 101 to provide location privacy protection to a user 103 from which the brain activity data is collected.

In one embodiment, the brain activity information includes, at least in part, neuron activation information. This neuron activation information results, for instance, from memory formation tied to a location at which the memory was formed. Accordingly, the mapping generated by the privacy preserving module 107 represents an association between specific brain activity and the location associated with the triggering of the brain activity. Detailed examples of the data structures associated with the mapping are discussed above with respect to FIG. 2 and FIGS. 3A-3D. However, it is noted that these data structures are provided as example embodiments, and are note intended as limitations. It is contemplated that the privacy preserving module 107 may use or store the mapping using any type of representation available to the components of the system 100.

In one embodiment, the privacy preserving module 107 creates the mapping as the brain monitoring data is collected and/or processed to identify and pair a brain activity (e.g., neuron activation) with a corresponding location. This process can occur in substantially real-time or performed on a batch basis.

In step 403, the privacy preserving module 107 determines one or more privacy policies associated with the one or more locations. In one embodiment, a user 103 associated with the brain activity information can specify one or more location-based privacy policies. These policies, for instance, may specify rules (if any) for protection the user's location information or other data with respect to one or more locations. In one embodiment, the privacy policies may also specify under what contexts or criteria privacy protection is to be activated or used. For example, a user may specify a policy that restricts location sharing while at certain locations or categories of locations. By way of example, the privacy policies can specify criteria such as threshold levels for location sensitivity, trustworthiness, etc. as well as the types of privacy preserving actions to take (e.g., restrict or anonymize brain activity information). In one embodiment, the privacy preserving module 107 can query for privacy policies using the one or more locations associated with the brain activity information of interest as a query parameter.

In step 405, the privacy preserving module 107 causes, at least in part, a transmission of the brain activity information, the one or more locations, or a combination thereof based, at least in part, on the one or more privacy policies. In other words, the privacy preserving module 107 can determine the locations associated with brain activity information and apply the privacy policies appropriate for the locations to the sharing of the brain activity information and/or any location data that can be extracted therefrom.

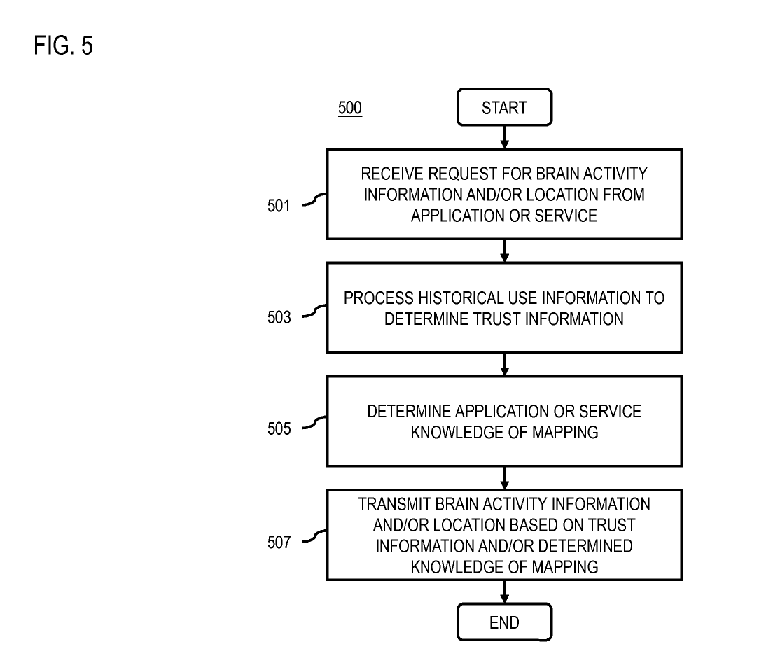

FIG. 5 is a flowchart of a process for transmitting protected brain activity information and/or locations to applications and/or services, according to one embodiment. In one embodiment, the privacy preserving module 107 performs the process 500 and is implemented in, for instance, a chip set including a processor and a memory as shown in FIG. 9. In addition or alternatively, the privacy preserving platform 111 may perform all or a portion of the process 500, and may also be implemented in the chip set including the processor and the memory as shown in FIG. 9.

The process 500 represents an embodiment in which the transmission or sharing of brain activity information is initiated by or directed an application 109 and/or a service 119 (e.g., applications and/or services that contextual or location-based information derived from brain activity information).

In step 501, the privacy preserving module 107 receives a request for the brain activity information and/or associated locations from at least one application 109, at least one service 119, or a combination thereof. In one embodiment, the request may be a one time request for access to a specific record or data point of brain activity information stream provided, for instance, by a monitoring device 105. In one embodiment, the application 109 and/or service 119 may direct the request specifically to the privacy preserving module 107. Alternatively, the privacy preserving module 107 may be implemented in a data flow path by which the privacy preserving module 107 can intercept and respond to requests sent from the application 109 and/or service 119 to the monitoring device 101 directly.

In step 503, the privacy preserving module 107 processes and/or facilitates a processing of historical use information associated with the at least one user with respect to the at least one application 109, the at least one service 119, or a combination thereof to determine trust information for the at least one application 109, the at least one service 119, or a combination thereof. In one embodiment, whether the privacy preserving module 107 evaluates trustworthiness as a factor or parameter for sharing brain activity information can be dictated by one or more location-based privacy policies.

In step 505, the privacy preserving module 107 determines whether the requesting applications 109 and/or services 119 have previous knowledge of or access to the mapping of the brain activity information to one or more locations. As previously discussed, the brain activity/location mapping data already known by an application 109 and/or service 119 plays a key role in deciding whether or not to reveal brain activity data to the application 109 and/or service 119. For example, sharing brain activity data may be privacy safe regardless of location sensitivity or trustworthiness if the application 109 and/or service 119 does not have sufficient prior data to reconstruct the mapping or pairing of a specific brain activity to a specific location.

In step 507, the privacy preserving module 107 causes, at least in part, a transmission of a sharing of the brain activity information and/or locations based, at least in part, on the trust information and/or the determined knowledge of the mapping. By way of example, depending on the trust information and/or the determined knowledge of the application 109 and/or service 119, the privacy preserving module 107 can apply different privacy preserving actions (e.g., restriction, anonymization, etc.) to enforce applicable privacy policies.

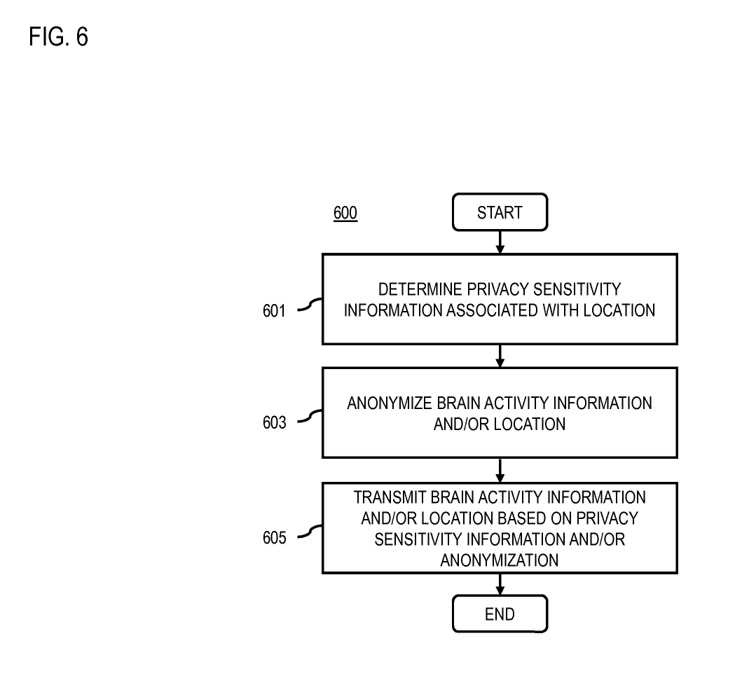

FIG. 6 is a flowchart of a process for using privacy sensitivity information and/or anonymization to protect location data extracted from brain activity information, according to one embodiment. In one embodiment, the privacy preserving module 107 performs the process 400 and is implemented in, for instance, a chip set including a processor and a memory as shown in FIG. 9. In addition or alternatively, the privacy preserving platform 111 may perform all or a portion of the process 400, and may also be implemented in the chip set including the processor and the memory as shown in FIG. 9.

In step 601, the privacy preserving module 107 determines privacy sensitivity information associated with one or more locations extracted from or otherwise associated with brain activity information. For example, the privacy preserving module 107 can determine how privacy sensitive a location is with respect to a user 103 to determine whether to share brain activity or location information. In one embodiment, the privacy preserving module 107 determines the privacy sensitivity information based, at least in part, on contextual information associated with the one or more locations, the at least one user, the brain activity information, the at least one application, the at least one service, or a combination thereof. In one embodiment, the privacy sensitivity information (e.g., a sensitivity level) and/or the contextual information can be determined based on real-time information associated with the user at a location. In this way, the preserving actions or policies to apply can be adaptively applied depending on the user's current context, emotional state, companions, activity, etc.

In step 603, the privacy preserving module 107 causes, at least in part, an anonymization of at least a portion of the brain activity information and/or locations based, at least in part, on the one or more privacy policies prior to the transmission of the brain activity information. In one embodiment, the anonymization is based on at least a partial obscuring of the mapping of the brain activity information to the one or more locations. As previously described, one means of anonymizing the brain activity information is to obscure or otherwise high the pairing of brain activity to a location. For example, if an entity receiving the brain activity information (e.g., an application 109 or service 119) does not have previous mapping information to infer the pairing of the brain activity to the location, then sharing of just one of the elements in the pair (e.g., the brain activity) can remain privacy safe. It is contemplated that the privacy preserving module 107 can use any means to obscure or anonymize the relationship between brain activity and location, including obscuring one or both of the activity or the location data itself.

In step 605, the privacy preserving module 107 causes, at least in part, a transmission or a sharing of the brain activity information and/or locations based on the privacy sensitivity information and/or anonymization of the brain activity information.

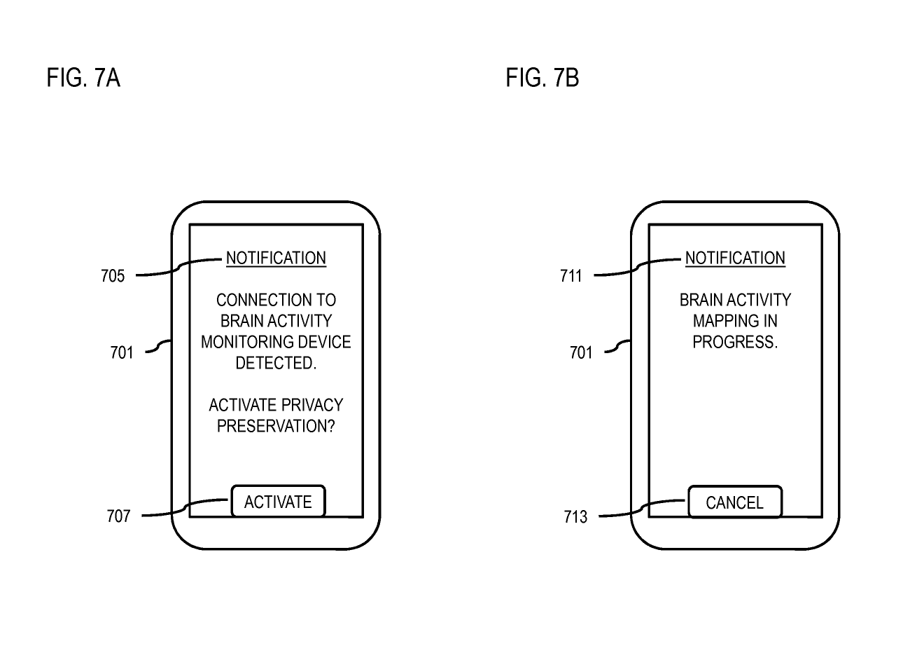

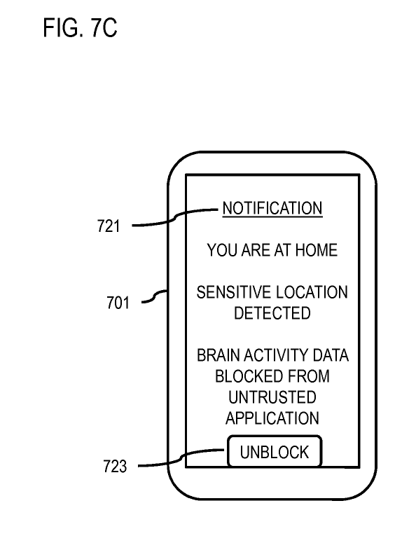

FIGS. 7A-7C are user interface diagrams depicting a process for protecting location data extracted from brain activity information, according to various example embodiments. In the example of FIG. 7A, a UE 701 has detected that a brain activity monitoring device (e.g., monitoring device 101) has been connected. In response, the UE 105 presents a notification 705 to alert a user 103 that a monitoring device has been detected, and asks the user 103 whether privacy preservation should be activated with respect to the brain monitoring data that will be collected. The notification 705, includes a control button 707 to activate privacy preservation.

On selecting the activate button 707, the privacy preserving module 107 begins monitoring and mapping brain activity information as described in the various embodiments above to begin protecting location data extracted from brain activity information. As shown in FIG. 7B, the UE 701 can present a notification 711 to inform the user 103 that brain activity mapping is in progress. The UE 701 can also present an option 713 to cancel the mapping operation.

In the example of FIG. 7C, the privacy preserving module 107 is actively monitoring requests for brain activity information from applications 109 executing on the UE 105. On detecting an untrusted application 109 that is seeking access to brain activity information in violation of the user 103's privacy policies, the UE 105 presents a notification 721 that the privacy preserving module 107 has detected that the user 103 is at a sensitive location (e.g., the user 103's home) and that, as a result, brain activity data has been blocked from being shared with the untrusted application 109.

The processes described herein for protecting location data extracted from brain activity information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

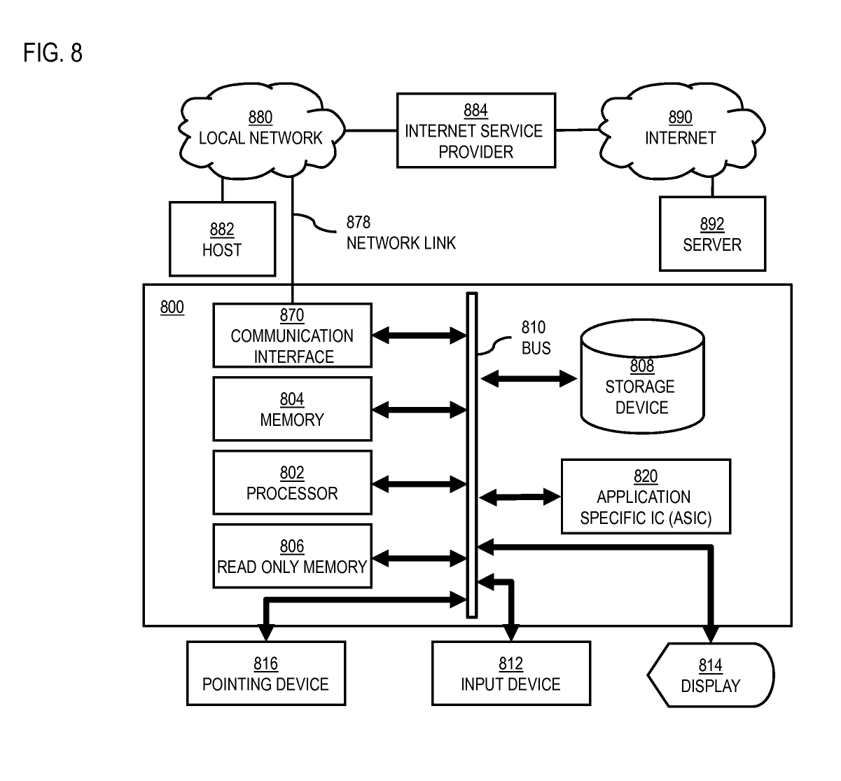

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to protect location data extracted from brain activity information as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of protecting location data extracted from brain activity information.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to protecting location data extracted from brain activity information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for protecting location data extracted from brain activity information. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for protecting location data extracted from brain activity information, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 113 for protecting location data extracted from brain activity information.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to protect location data extracted from brain activity information as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of protecting location data extracted from brain activity information.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to protect location data extracted from brain activity information. The memory 905 also stores the data associated with or generated by the execution of the inventive steps.

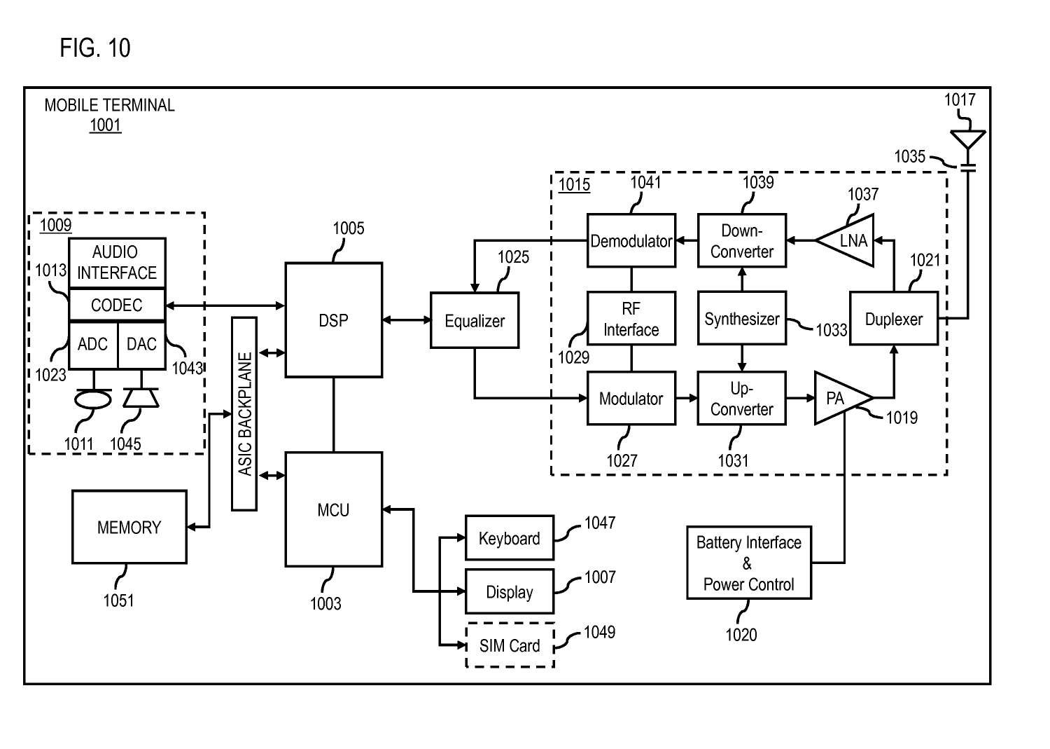

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of protecting location data extracted from brain activity information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of protecting location data extracted from brain activity information. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to protect location data extracted from brain activity information. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
causing, at least in part, a mapping of brain activity information associated with at least one user to one or more locations visited by the at least one user;
determining one or more privacy policies associated with the one or more locations; and
causing, at least in part, a transmission of at least the brain activity information, the one or more locations, or a combination thereof based, at least in part, on the one or more privacy policies.

2. A method of claim 1, further comprising:
receiving a request for the brain activity information, the one or more locations, or a combination thereof from at least one application, at least one service, or a combination thereof,
wherein the transmission of the brain activity information, the one or more locations, or a combination thereof is to the at least one application, the at least one service, or a combination thereof.

3. A method of claim 2, further comprising:
processing and/or facilitating a processing of historical use information associated with the at least one user with respect to the at least one application, the at least one service, or a combination thereof to determine trust information for the at least one application, the at least one service, or a combination thereof,
wherein the transmission of the brain activity information, the one or more locations, or a combination thereof is further based, at least in part, on the trust information.

4. A method of claim 2, wherein the transmission of the brain activity information, the one or more locations, or a combination thereof is further based, at least in part, on determining whether the at least one application, the at least one service, or a combination thereof has access to the mapping of the brain activity information to the one or more locations.

5. A method of claim 1, further comprising:
determining privacy sensitivity information associated with the one or more locations,
wherein the transmission of the brain activity information, the one or more locations, or a combination thereof is further based, at least in part, on the privacy sensitivity information.

6. A method of claim 5, further comprising:
determining the privacy sensitivity information based, at least in part, on contextual information associated with the one or more locations, the at least one user, the brain activity information, the at least one application, the at least one service, or a combination thereof.

7. A method of claim 1, further comprising:
causing, at least in part, an anonymization of at least a portion of the brain activity information, the one or more locations, or a combination thereof based, at least in part, on the one or more privacy policies prior to the transmission of the brain activity information.

8. A method of claim 7, wherein the anonymization is based on at least a partial obscuring of the mapping of the brain activity information to the one or more locations.

9. A method of claim 1, wherein the one or more locations include, at least in part, one or more physical locations, one or more virtual locations, or a combination thereof.

10. A method of claim 1, wherein the brain activity information includes, at least in part, neuron activation information.

11. An apparatus comprising:
at least one processor; and
at least one memory including computer program code for one or more programs,
the at least one memory and the computer program code configured to, with the at least one processor, cause the apparatus to perform at least the following,
cause, at least in part, a mapping of brain activity information associated with at least one user to one or more locations visited by the at least one user;
determine one or more privacy policies associated with the one or more locations; and
cause, at least in part, a transmission of at least the brain activity information, the one or more locations, or a combination thereof based, at least in part, on the one or more privacy policies.

12. An apparatus of claim 11, wherein the apparatus is further caused to:
receive a request for the brain activity information, the one or more locations, or a combination thereof from at least one application, at least one service, or a combination thereof,
wherein the transmission of the brain activity information, the one or more locations, or a combination thereof is to the at least one application, the at least one service, or a combination thereof.

13. An apparatus of claim 12, wherein the apparatus is further caused to:
process and/or facilitate a processing of historical use information associated with the at least one user with respect to the at least one application, the at least one service, or a combination thereof to determine trust information for the at least one application, the at least one service, or a combination thereof,
wherein the transmission of the brain activity information, the one or more locations, or a combination thereof is further based, at least in part, on the trust information.

14. An apparatus of claim 12, wherein the transmission of the brain activity information, the one or more locations, or a combination thereof is further based, at least in part, on determining whether the at least one application, the at least one service, or a combination thereof has access to the mapping of the brain activity information to the one or more locations.

15. An apparatus of claim 11, wherein the apparatus is further caused to:
determine privacy sensitivity information associated with the one or more locations,
wherein the transmission of the brain activity information, the one or more locations, or a combination thereof is further based, at least in part, on the privacy sensitivity information.

16. An apparatus of claim 15, wherein the apparatus is further caused to:
determine the privacy sensitivity information based, at least in part, on contextual information associated with the one or more locations, the at least one user, the brain activity information, the at least one application, the at least one service, or a combination thereof.

17. An apparatus of claim 11, wherein the apparatus is further caused to:
cause, at least in part, an anonymization of at least a portion of the brain activity information, the one or more locations, or a combination thereof based, at least in part, on the one or more privacy policies prior to the transmission of the brain activity information.

18. A computer-readable storage medium carrying one or more sequences of one or more instructions which, when executed by one or more processors, cause an apparatus to perform:
causing, at least in part, a mapping of brain activity information associated with at least one user to one or more locations previously visited by the at least one user;
determining one or more privacy policies associated with the one or more locations; and
causing, at least in part, a transmission of the brain activity information based, at least in part, on the one or more privacy policies.

19. A computer-readable storage medium of claim 18, wherein the apparatus is caused to further perform:
receiving a request for the brain activity information from at least one application, at least one service, or a combination thereof,
wherein the transmission of the brain activity information is to the at least one application, the at least one service, or a combination thereof.

20. A computer-readable storage medium of claim 19, wherein the apparatus is caused to further perform:
processing and/or facilitating a processing of historical use information associated with the at least one user with respect to the at least one application, the at least one service, or a combination thereof to determine trust information for the at least one application, the at least one service, or a combination thereof,
wherein the transmission of the brain activity information is further based, at least in part, on the trust information.

21-48. (canceled)
